(19) United States
(12) Patent Application Publication
(10) Pub. No.: US 2002/0184525 A1
(43) Pub. Date: Dec. 5, 2002

(54) Style sheet transformation driven firewall access list generation

(76) Inventor: Lebin Cheng, Fremont, CA (US)

Correspondence Address: HEWLETT-PACKARD COMPANY, Intellectual Property Administration, P.O. Box 272400, Fort Collins, CO, 80527-2400, US

(21) Appl. No.: 09/823,387

(22) Filed: Mar. 29, 2001

(51) Int. Cl. G06F 15/16

(52) U.S. Cl. 713/201

(57) ABSTRACT

A method and apparatus for configuring a network security system. A registry data structure includes useful information about the network, such as definitions of roles within the network. The registry may also include information regarding the topology of the network. Documents that contain network security policies are linked to the registry data structure. The policy documents may then be transformed into device-specific configuration documents using a document transformation algorithm, which takes a document of a certain format as input and generates a document in a different format as output. Various different scripts may control the transformation process to achieve compatibility with security devices from different vendors. An advantage of the invention is that major network management tasks, including policy enforcement, may be done by document transformations. Once adopted, a security strategy may be changed in order to adapt to changing business requirements.

### FIELD OF THE INVENTION

The present invention relates to the field of network security. More particularly, the present invention relates to the field of configuration and management of network security systems.

### BACKGROUND OF THE INVENTION

A network security firewall is a device that is generally positioned between two networks and is configured to implement network security policies. The security policies specify which communications between the networks are permissible and which communications are not. Thus, depending upon how it is configured, the firewall will permit certain communications between the networks and prohibit others. Business enterprises typically use firewalls to separate and protect their internal corporate network from the external, potentially hostile Internet.

A typical firewall implementation enforces a network security policy that is centrally defined and uniformly applied across an enterprise. For example, FIG. 1 illustrates a network 100 that is protected by two firewalls 102 and 104. The firewalls 102 and 104 are positioned so that all traffic between the network 100 and external networks 106, such as the Internet or an extranet, must pass through one of the firewalls 102 or 104. Accordingly, the firewalls 102 and 104 monitor such communications and prevent unwanted traffic from entering or exiting the network 100.

As can be seen from FIG. 1, the firewall devices 102 and 104 form a security domain boundary by which the entire network 100 of the enterprise is protected from the outside 106 by the same security policies. Such a monolithic security system has its advantages. For example, the security system itself can be centrally managed for security policy definition and consistency of implementation. Accordingly, the business enterprise may employ a centralized group of experts who are responsible for security and who configure the firewall devices 102 and 104 using conventional firewall management tools.

Such a monolithic security policy management system, however, also has certain disadvantages. For example, large business enterprises tend to have geographically distributed business divisions. Further, the business divisions often have very different security requirements due to different, sometimes even conflicting, security needs. This is especially true of enterprises that participate in the “Internet economy.” For such businesses, it is not feasible to enforce a uniform, low-level firewall policy across the enterprise.

As a result, the network of a business enterprise may be divided into many different sub-networks (also referred to as network compartments) so as to give business divisions of the enterprise local control over security. In such a distributed environment, implementation and management of local firewall devices is delegated to local business groups. While this security strategy may meet specific business needs, it increases the difficulty and complexity of managing network security.

A goal for a distributed network security system is to allow high degree of local autonomy without compromising the security of the enterprise network as a whole. Several firewall management products offered by major firewall vendors are considered “point solutions” due to their proprietary nature. Most of these solutions are satisfactory when used to manage their own products, but their functions are very limited or non-existent when it comes to managing firewalls of other vendors. In addition, proprietary designs of the management systems tend to make cross-platform policy definition difficult.

For example, a firewall management toolkit developed by the Bell Lab of Lucent Technologies called Firmato supports policy abstraction and separates policy definition from actual device-specific implementations. The Firmato toolkit takes a top-down approach to enforce a high-level policy across the enterprise. A system program is used to interpret high-level policies and translate them into device-specific configurations. However, Firmato is a closed system. As such, it uses a proprietary modeling language and a proprietary compiler for access control list generation. In addition, the Firmato toolkit has built-in a security and management system. Thus, the Firmato toolkit lacks support for a wide variety of firewall devices and run-time platforms.

The Salinas Group takes a service approach to network security management by offering a service called ManagedFirewall. This service allows an enterprise to completely outsource the management of their network. ManagedFirewall provides a rather limited, web-based “policy configuration tool” for enterprise users. However, it is also a closed, centralized system since system configuration is performed via a central “management hub” offered by the service.

None of the proprietary firewall management tools is sufficiently scalable for a large, heterogeneous enterprise network since their enforcement tools are not compatible with firewalls of different vendors. Thus, an enterprise whose organizations use different firewall products ends up with a set of incompatible firewall management tools. As a result, network security management efforts in large enterprises are often fragmented and prone to human errors.

### SUMMARY OF THE INVENTION

The invention is a method and apparatus for configuring a network security system. A registry data structure includes useful information about the network, such as definitions of roles within the network. The registry may also include information regarding the topology of the network. Documents that contain network security policies are linked to the registry data structure. The policy documents may then be transformed into device-specific configuration documents using a document transformation algorithm, which takes a document of a certain format as input and generates a document in a different format as output. Various different scripts may control the transformation process to achieve compatibility with security devices from different vendors. An advantage of the invention is that major network management tasks, including policy enforcement, may be done by document transformations. Once adopted, a security strategy may be changed in order to adapt to changing business requirements.

Thus, a document-based model for network security management is presented. Preferably, information including network security policies, role definitions and topology information are in the form of documents, such as Extensible Markup Language (XML) documents. XML Stylesheet Transformation (XSLT) is preferably used to transform the XML documents into formats appropriate for configuring the actual devices used in the network to implement the desired security policies. While another document format language can be used, an advantage of using an industry standard document format language, such as XML, is that the invention can be implemented using open-standard tools. For example, XML and XSLT parsers and processors are widely available.

Due to the popularity of the World Wide Web, a number of tools and third-party systems are readily available for the distribution, management, and transformation of documents. Accordingly, Standard off-the-shelf web security and management solutions designed for the World Wide Web can be used to secure and manage the management system itself, including its documents. These tools include, but are not limited to, a document management system with proper version control, a document security system for access control, and a document editing and query subsystem. The documents themselves may also be made available via the World Wide Web. The specific choices of security and management tools for the system are open to implementers of the invention.

The invention provides a network management solution that is open, scalable, and extensible, unlike prior systems. It supports policy abstraction and separates policy definition from actual device-specific implementation. Accordingly, the invention can be used across security devices from various different vendors.

### BRIEF DESCRIPTION OF THE DRAWINGS

FIG. 1 illustrates an enterprise network and security system in accordance with the prior art;

FIG. 2 illustrates a compartmentalized enterprise network in which the present invention may be implemented;

FIG. 3 illustrates diagrammatically how responsibilities for a network security system may be allocated in accordance with the present invention;

FIG. 4 illustrates a block schematic diagram of a general-purpose computer system, which may be used for configuring a network security system in accordance with the present invention;

FIG. 5 illustrates diagrammatically an exemplary registry data structure in accordance with the present invention;

FIG. 6 illustrates diagrammatically the registry data structure of FIG. 5 implemented as a directory containing XML documents in accordance with the present invention; and

FIG. 7 illustrates diagrammatically transformation of XML documents of the registry of FIGS. 5 and 6 into a device-specific configuration document in accordance with the present invention.

### DETAILED DESCRIPTION OF A PREFERRED EMBODIMENT

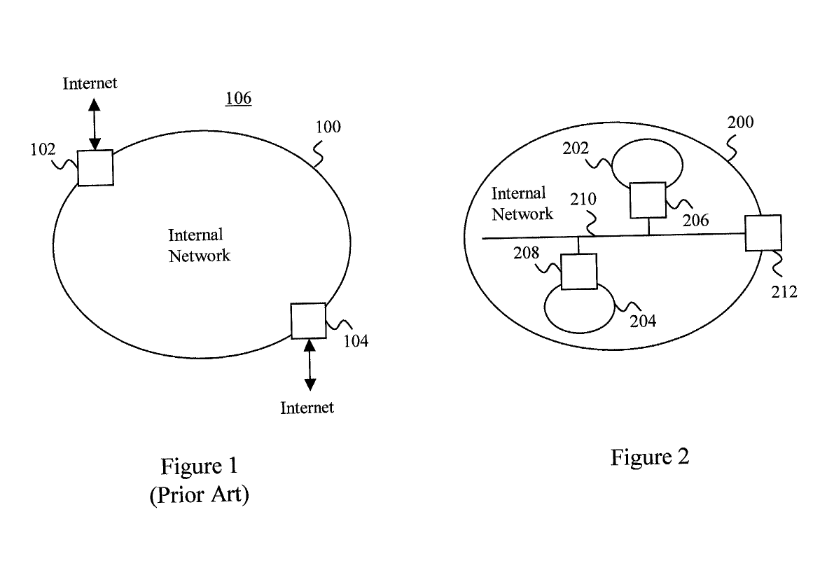

FIG. 2 illustrates a compartmentalized network 200 in which the present invention may be implemented. As illustrated in FIG. 2, the network 200 of a business enterprise may be compartmentalized into multiple sub-networks 202 and 204. A firewall device may protect each sub-network 202 or 204. Thus, as shown in FIG. 2, a firewall device 206 protects the sub-network 202, while a firewall device 208 protects the sub-network 204. The sub-networks 202 and 204 may communicate with each other, for example, via a backbone 210. A firewall 212 may separate the entire network 200 from networks outside the network 200. Alternately, one or more of the sub-networks 202 and 204 may communicate directly with other, external networks via their respective firewall device 206 or 208. It will be apparent that more or fewer sub-networks may be included in the network 200. Further, each sub-network 202 and 204 may be further compartmentalized to include multiple sub-networks.

Thus, rather than a monolithic firewall, a set of localized firewall “compartments” are implemented across the enterprise. A firewall compartment defines an autonomous security domain. A compartment may contain compartments of finer security policy granularity. For example, the corporate firewall compartment 212 may implement only a small set of low level policies to protect the corporate network backbone 210 from IP address spoofing and basic denial of service. Business divisions may control the security policies of the included local compartments 202 and 204. While the firewalls are illustrated in FIG. 2 as specific hardware devices, they may be implemented as virtual devices. For example, the policies of the corporate firewall 212 may be implemented by common policies of the firewalls 206 and 208.

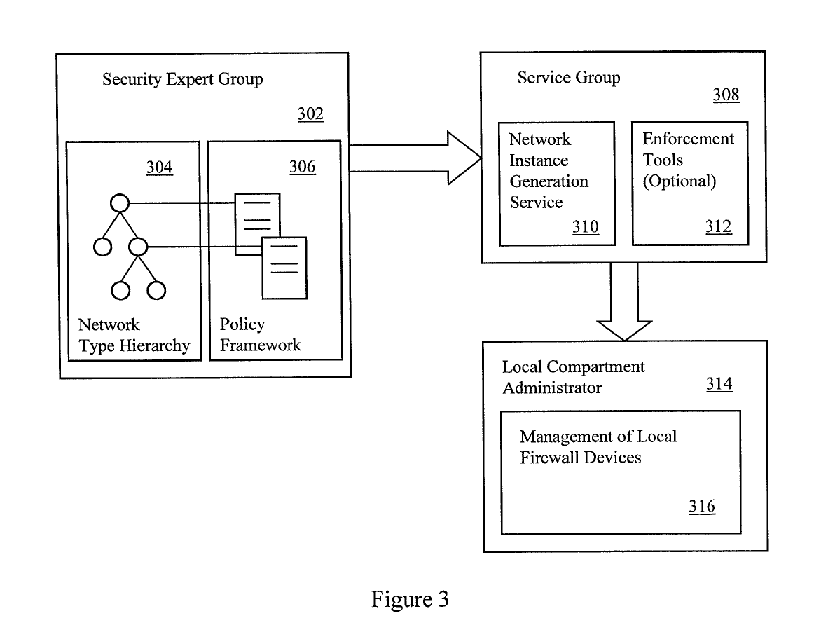

FIG. 3 illustrates diagrammatically how responsibilities for a security system for a network, such as the network 200 of FIG. 2, may be allocated in accordance with the present invention. Rather than a single corporate policy, a central corporate policy definition group 302 may define a hierarchy 304 of network types and linked security policy documents 306. The registry type hierarchy 304 is a data structure for storing useful information about the network, such as applications the network supports and topology of the network. Because the network policy documents 306 are linked to the registry 304, they may be considered part of the registry 304.

A corporate service group 308 may be responsible for providing an “instantiation” service 310, which generates instances of firewall compartments implementing the appropriate policies based on the topology of compartments and the network types of those compartments. The service group 308 may also provide tools 312, such as for the distribution, management and transformation of documents.

Using the type hierarchy 304 and policies 306 developed by the expert group 302 and the instantiation service 310 provided by the service group 308, a local administrator 314 may then perform local management functions 316. The local administrator 314 may have the freedom to choose from among the tools 312. For example, to aid the local administrator 314, the corporate service group 308 may provide a default set of tools for device specific configuration generation. However, it should be noted that the invention is preferably enforcement tool independent so as to be more open and scalable than prior systems.

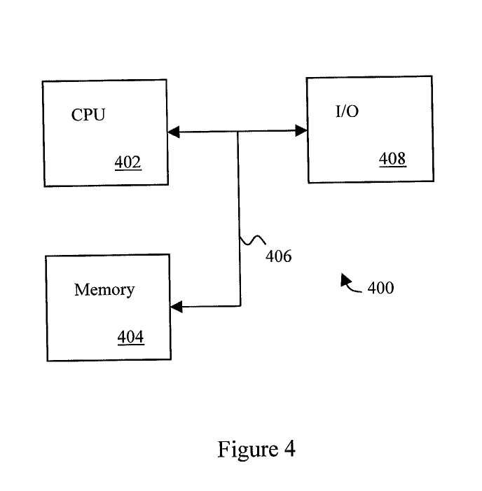

FIG. 4 illustrates a block schematic diagram of a general-purpose computer system 400, which may be included in the network 200 (FIG. 2) for implementing a network security system in accordance with the present invention. The computer system 400 may include a general-purpose processor 402, a memory 404, such as persistent memory (e.g., a hard disk) and transitory memory (e.g., RAM), a communication bus 406, and input/output devices 408, such as a keyboard, monitor and mouse. The computer system 400 is conventional. As such, it will be apparent that the system 400 may include more or fewer elements than shown in FIG. 4 and that other elements may be substituted for those illustrated in FIG. 4.

Functions of the security expert group 302, service group 308 and local administrator 314 may be performed using a general-purpose computer system, such as the system 400 of FIG. 4. Accordingly, the network type hierarchy 304 and policies 306 may be stored in the computer memory 404, such as in a hard disk.

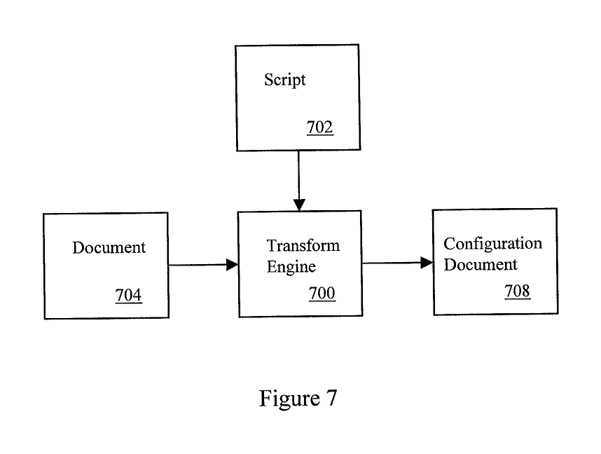

The document-based policy definition and management system of the present invention may include four major components: the registry type hierarchy 304 (FIGS. 3, 5 and 6), a policy definition framework 306 (FIG. 3), a transformation process and system 700 (FIG. 7) and a set of supporting tools 312 (FIG. 3).

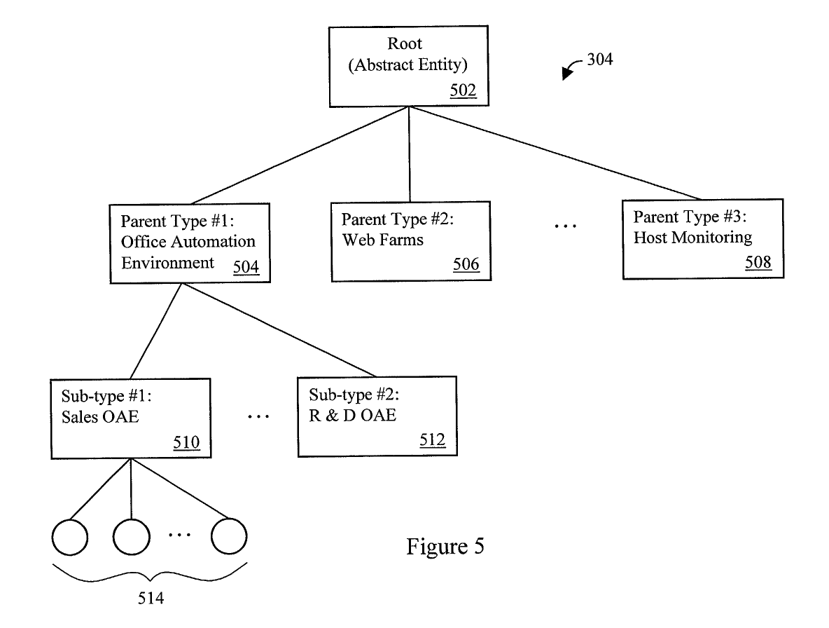

The registry 304 is an entity in which system-wide information about the network and network policies may be stored. Storage and management of registry data may be in a single centralized location, such as a hard disk of memory 404 of the system 400 (FIG. 4) or may be distributed throughout the network 200 (FIG. 2). FIG. 5 illustrates diagrammatically an exemplary registry data structure 304 in accordance with the present invention. The registry 304 is preferably arranged as a type hierarchy, similar to that of an object system and analogous to a schema for a database.

As shown in FIG. 5, a root 502 of the registry 304 may be an abstract entity. Parent types 504, 506 and 508 may be positioned in a next level down in the hierarchy from the root 502. Each of the parent types 504, 506 and 508 may have one or more associated subtypes positioned at a next level down from the parent. Thus, as shown in FIG. 5, the parent type 504 is associated with two subtypes 510 and 512. Each subtype 510-512 may have fields in network instances 514 for other information, such as administrative and network topology information.

A network type represents the “role” of a network or network compartment. A role may be a set of network applications that a network or network compartment supports. Many different roles may be defined. Thus, network and network compartments may be categorized based on the applications they support. This is useful information for storing in the registry 304, because network roles tend to be stable. For example, many enterprise networks share a relatively small number of mission-critical network applications, which do not change as frequently as the underlying physical network. When application version upgrades occur, these upgrades generally do not often significantly change network behaviors. As an example, a web server upgrade will not typically alter the HTTP port of the server.

In addition, by having network role definitions, development and management of security policy definitions may be simplified. For example, administrators maintaining security policies need not be concerned with low-level network behaviors nor network topologies. Rather, policy definitions can be based on the roles and, thus, on the supported applications. Accordingly, the physical topology of the network may be changed or the network behavior profile of a certain network application modified without affecting existing security policies.

In addition to the role definitions and security policies, information stored in the registry 304 may also include administrative data fields and network topology information. The administrative data fields may, for example, specify owner contacts, information about network devices, human readable description, and so forth. The network topology information associated with an instance of a role may include, for example, IP address assignment, site information, physical network segments, partitions, compartments and so forth. Thus, a network type stored in registry 304 may be a combination of a role definition, a set of administration data fields, and topology information defining the physical network segment(s) to which the role definition and administration data applies. Fields for administration data and topology information, e.g., fields of network instances 514, may be optional for parent types, however, because the parent types may be abstract types without instances mapped to physical network segments. Accordingly, parent types 504, 506 and 508 are illustrated in FIG. 5 with such fields. The data types define the semantics of the data stored in the document.

Simple class inheritance rules may be followed. Thus, subtypes preferably inherit information, such as security policies, from their associated parent type. For example, parent type 504 may be an abstract Office Automation Environment (OAE) type for desktop stations. Subtypes of the OAE type may be for workstations in a sales office or in a research and development (R&D) department. Accordingly, the subtype 510 may be a Sales Office OAE type, while the subtype 506 may be an R&D OAE type. This allows a common set of security policies and applications to be defined for both subtypes 510 and 512 in parent type 504 and different sets and different sets of applications and security policies to be defined for the subtypes 510 and 512 at the subtype level. Leaf-notes 514 may provide subtype instances that correspond to physical network segments. While a two-level hierarchy works well for most purposes, it will be apparent that additional levels may be provided in the hierarchy of the registry 304.

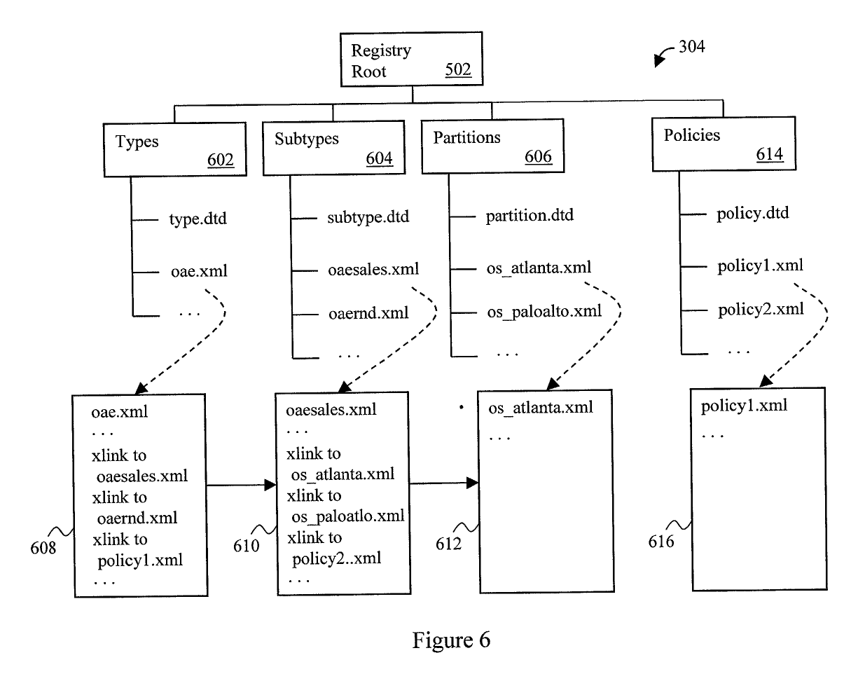

Both data type information and data instances may be stored in documents of various document types. Thus, the entire type hierarchy 304 may be implemented as directories containing XML documents. FIG. 6 illustrates diagrammatically the registry data structure 304 of FIG. 5 implemented as a directory containing XML documents in accordance with the present invention. Links across documents are preferably implemented using XLinks. Further, additional XLinks can be included in the hierarchy 304 to form a graph to facilitate more sophisticated queries. It is also possible to generate metadata about documents, such as document indices, to ease management of the document system when the number of document instances increases.

Unlike an object system, a file system does not generally provide built-in support for object typing. Therefore, type information as well as information of network instances is preferably stored explicitly in the document structure. Thus, both type definitions and object instances may be implemented as document instances. For a parent type, the type definition may be included in a Document Type Definition (DTD) in a parent directory. This is shown in FIG. 6 by the DTD “type.dtd” associated with the parent type directory 602. The document instance of a parent type may also be included in the parent directory. Thus, in FIG. 6, the parent type directory 602 also contains document, “oae.xml.” The “oae.xml” file is a document instance containing information about the OAE type 504 (FIG. 5). The parent document may be mapped to a list of subtype documents. This is shown in FIG. 6 by the document instance 608, “oae.xml” including a list of links to subtype documents “oaesale.xml” (for the sales office subtype 510 of FIG. 5) and “oaernd.xml” (for the R&D subtype 512 of FIG. 5).

A similar mapping may be performed for subtypes, except that the list of subtype documents may be replaced with a list of one or more documents representing instances of network segments or compartments. As shown in FIG. 6, subtype document 610 “oaesales.xml” in subtype directory 604 includes a list of links to instances of network compartments. A partition directory 606 may include the documents linked by subtype documents. This is shown in FIG. 6 by the document 612 “os-atlanta.xml,” which may include information about the instance of a network compartment for a sales office located in Atlanta.

The policy definition framework can be also viewed as part of the registry 304. Unlike many conventional security systems where policies are defined, stored, and translated in isolation by a closed application, in the present invention policies may be defined and stored as ordinary documents based on standard formats. The policy definition framework and its enforcement are preferably decoupled. Thus, network administrators are free to choose their own tools to interpret the documents and implement the policies. However, the same transformation process used for other documents in the system may be used to enforce the policies by transforming the policy documents to specific device configurations. This simplifies the management task of the management system itself.

There may be two kinds of network security policies based on the role of a network or network compartment: client policy and server policy. A client policy targets host machines running inside the network boundary as clients of a network application. Likewise, a server policy targets host machines running as network application servers inside the network boundary. In general, client policies are related to outbound network traffic, whereas, server policies control inbound network traffic. There are, however, exceptions to these general cases. One example is passive FTP where the FTP server must initiate data connections to downloading clients.

Documents that define security policies may be linked to the type and partition document instances of the registry 304. As shown in FIG. 6, policy directory 614 in the registry 304 includes policy documents “policy1.xml” and “policy2.xml.” The links in document 608 of the parent type directory 602 include a link to the policy document “policy1.xml,” which is shown in FIG. 6 as document 616. Similarly, the list of links in the document 610 of the subtype directory 610 includes a link to policy document “policy2.xml.” In a preferred embodiment, the links to policy documents are implemented as Xlinks.

Placement of a policy in the type hierarchy 304 preferably determines the enforcement scope of the policy. For example, if a parent node has a link to a policy document, policies in this document are considered the base policy for that type and enforced in all nodes in the branch. Thus, the policies of document 616 preferably apply to all subtypes of the type OAE since the type OAE includes a link to policy document 616. For conflict resolution, however, policies in a subtype node preferably take precedence over base policies. Since subtypes and instances preferably inherit policies from their parents as base-line policies, a policy enforcement process must traverse the registry hierarchy and implement all policies defined from root to leaf nodes.

Like the type hierarchy, the policy framework can be extended if more sophisticated policies and/or policy enforcement processes are needed. For example, the policy definition language can be enriched to include applications with very peculiar network behaviors, or even host specific information, such as the security level of a server platform.

The extensible markup language (XML), with related standards and tools, provides a preferred platform for implementation of the invention. In sum, XML is a set of conventions for designating a textual format for data and a common syntax for expressing structure in data. However, any document formatting language could be used with appropriate modifications. SGML (Standard Generalized Markup Language) and HTML (Hyer Text Markup Language) are examples of other document formatting languages. More sophisticated format languages, such as the XML Schema language, can be used to replace the simple Document Type Definition (DTD) language to describe more complex type hierarchies.

A transformation process takes a document of certain format as input and generates documents in a different format as output. An aspect of the invention includes performing network management tasks, including firewall device configuration for policy enforcement, through a series of one or more document transformations. Thus, policy translation may be treated as a special case of document transformation.

FIG. 7 illustrates diagrammatically transformation of XML documents of the registry 304 of FIGS. 5 and 6 into device-specific configuration documents in accordance with the present invention. As shown in FIG. 7, a document transformation engine 700, operating under control of a script 702, may transform a document 704, such as a policy document from the registry 304, into a configuration document 708. The configuration document 708 may then be used to configure a firewall device. The engine 700 may, for example, operate on the computer system 400 of FIG. 4.

Because the security policies are preferably defined in XML documents, conventional XML transformation tools may be used to transform the documents. More particularly, the engine 700 may include a style sheet driven access list generation program that operates in accordance with the XML Stylesheet Language for Transformations (XSLT) standard developed by the W3C organization. An exemplary engine may be an XSLT processing engine known as Xalan, which was developed by the xml.apache.org project. It will be apparent, however, that another engine may be used. The engine 700 takes the original XML document 704 and an XSLT script 702 as input and generates output documents 708 in other formats.

The XSLT script 702 may control the transformation process using XSL templates. A typical XML parser parses the source XML document and generates an XML tree. An XSL template module matches a branch of this XML tree and contains rules for the generation of a new output XML tree. The XSLT processing engine 700 traverses the source XML tree in a top-to-bottom manner, and applies all matching XSL templates. A variety of scripts may be provided for transforming the same policy document 700 into different formats that are appropriate for configuring firewall devices from various different vendors. Preferably, the format of the output document 708 is XML, HTML, or plain text. Plain text is sufficient for most device-specific configurations.

Most firewall devices support batch configuration, which allows remote device management via downloading and executing of configuration scripts. In normal cases, these scripts are simply text documents. As a result, policy enforcement can be achieved by transforming policy documents to device specific configuration script documents 708, which may be used to configure the network security devices to implement the desired security policies.

The use of standard style sheet transformation for policy enforcement eliminates the need for a proprietary enforcement program often required in similar systems. This not only simplifies implementation, but also makes it easier for delegation of the policy enforcement tasks. Network administrators responsible for the implementation of network policies have the flexibility to choose any transformation engine most suitable to their environment. They can use free or commercial XSLT tools, which are becoming available on almost all popular operating systems. Further, XSLT scripts can be shared among administrators. Consequently, no longer a central group or deployment of proprietary programs is necessary for the enforcement of enterprise network security policies.

An advantage of XML over other document representation is the availability of tools. XML processors can be found on all major platforms, including Windows, major Unix variants, and Linux. As a result, the use of XML not only reduces development cost by eliminating the need for a proprietary processing program 700, but also eases deployment and support of the overall management system by allowing local administrators to choose and support their own tools.

Standard, off-the-shelf document management tools may be used to support the management system itself. These include, but are not limited to, a document management system with proper version control, a document security system for access control, and a document editing and query subsystem. Many operating systems already provide some basic level of protection for documents in the file system. Thus, no additional precautions are required to ensure the security of the documents within the registry 304 (FIGS. 5 and 6). If more sophisticated security systems are desired, web security products are already available.

A specific example of an application definition module that defines the network behavior of a network application is provided. This is an example definition of a “ping” application:

<AppModule id=“ping”>

<Client>

<Outbound>

<Description>

ping uses icmp echo coming in

</Description>
<Protocol name=“icmp”>

<Subtype>echo</Subtype>

</Protocol>

</Outbound>
<Inbound>

<Description>

icmp echo reply

</Description>

<Protocol name=“icmp”>

<Subtype>echo-reply</Subtype>

</Protocol>

</Inbound>

</Client>
<Server>

<Outbound>

<Description>

icmp echo reply

</Description>

<Protocol name=“icmp”>

<Subtype>echo-reply</Subtype>

</Protocol>

</Outbound>
<Inbound>

<Description>

ping uses icmp echo coming in

</Description>
<Protocol name=“icmp”>

<Subtype>echo</Subtype>

</Protocol>

<Inbound>

</Server>

</AppModule>

In the example, both client and server behaviors are defined following the generally accepted definition of “client” and “server.” However, the distinction is sometimes arbitrary. In the case of “ping,” a host answering “ping” is considered to be a server, while a client initiates the ping. Sub-elements of the client and server elements may be identical. They define the inbound and outbound traffic in terms of their network protocols. In implementation, default rules (e.g. client and server network behaviors are inverse of each other) can be used to simplify such definitions. A specific example of network security policies defined based on the application definitions is provided below:

<Allow from=“HostMon” tp=“OAE”><AppEntry appid=“ping” role=“clnt”/>

</Allow>

The “from” and “to” attributes define the two networks involved. Both “HostMon” and “OAE” are alias referencing a network partition or a group of network partitions. In this example, “HostMon” is an alias for all network partitions with the Host Monitoring role, as “OAE” is an alias for all Office Automation Environment networks. The “role” attribute directs a policy enforcement process to look into either the “Client” portion or the “Server” portion of the application definition module. In summary, this policy example says, “Any host in the Host Monitoring network is allowed to ping any host in the OAE network. Those pings must be initiated by a Host Monitoring host, but not the other way around.”

A specific example of an XSLT script segment is provided to show interaction between two kinds of XSLT templates: general policy processing templates and device-specific templates. General policy templates may process the policy definitions, perform high-level tasks, such as consistency checking, and call device specific templates to generate device specific configurations.

<xsl:template name=“PerPEntryGen”>

<xsl:param name=“srcid”>Any</xsl:param>
<xsl:param name=“desid”>Any</xsl:param>
<xsl:param name=“action”>deny</xsl:param>
<xsl:for-each select=“Inbound/Protocol”>

```
<xsl:call-template name=“DeviceACLGen”>
  <xsl:with-param name=“srcid”>
    <xsl:value-of select=“$srcid”/>
      </xsl:with-param>
    <xsl:with-param name=“desid”>
      <xsl:value-of select=“$desid”/>
    </xsl:with-param>
    <xsl:with-param name=“action”>
      <xsl:value-of select=“$action”/>
    </xsl:with-param>
    <xsl:with-param name=“aid”>
      <xsl:value-of select=“$inacl_id”/>
    </xsl:with-param>
  </xsl:call-template>
```

</xsl:for-each>
...<!-acl gen for the rest -->

</xsl:template>
<xsl:template name=“DeviceACLGen”>

<xsl:param name=“srcid”>Any</xsl:param>
<xsl:param name=“desid”>Any</xsl:param>
<xsl:param name=“action”>deny</xsl:param>
<xsl:param name=“acl_id”>1111</xsl:param>
...<!-- rest of device specific generation -->
</xsl:template>

This example shows two named templates: “PerPEntryGen” and “DeviceACLGen.” The “PerPEntryGen” template may be called whenever a network policy entry is matched in the XML source tree. This matches every <AppEntry>item as shown in the example policy in the previous section. It takes three arguments: “srcid,” “desid,” and “action.” Both “srcid” and “desid” are aliases referring to network segments. They are passed along the chain of calls and mapped into IP subnets in the final transformation. There are currently two possible values for the “action” variable: permit and deny. The values in the <xsl:param>item are default values for the arguments.

In addition to those arguments of “PerPEntryGen,” the “DeviceACLGen” template takes an additional argument “acl-id” (access list identifier). Most firewall devices need certain unique identifiers for access lists. The example XSLT script takes the value from a user defined global parameter for the inbound access list identifier.

Thus, a security management system has been described that provides for distributed management of both security policies and enforcement. The system may be used to manage a large-scale enterprise network without having to rely on proprietary or closed system tools. Rather, the system is open, scalable, and extensible. Policy definition and enforcement tasks can be safely delegated to multiple entities. In addition, owners of local networks are able to make local changes without affecting other parts of the system. However, a system-wide policy may also be automatically in effect in all sub-systems as a base-line policy.

While the foregoing has been with reference to particular embodiments of the invention, it will be appreciated by those skilled in the art that changes in these embodiments may be made without departing from the principles and spirit of the invention, the scope of which is defined by the appended claims.

What is claimed is:

1. A method of configuring a network security system, comprising:
a. forming a registry data structure for defining roles within a network;
b. mapping network security policies to the registry data structure, said network security policies being contained in one or more policy documents stored in machine readable form; and
c. using a document transformation algorithm to transform the policy documents into one or more device-specific configuration documents stored in machine-readable form.

2. The method according to claim 1, further comprising generating instances of the roles and associated security policies, each instance being mapped to physical segments of the network.

3. The method according to claim 1, further comprising distributing the device-specific configuration documents to network entities for implementing the network security policies.

4. The method according to claim 1, wherein the registry data structure comprises a collection of documents that include information regarding the network roles and topology of the network.

5. The method according to claim 1, wherein the registry data structure comprises a hierarchy of network types, each type comprising a definition of a network role.

6. The method according to claim 5, wherein each network role is representative of a set of applications to be supported by the network.

7. The method according to claim 5, wherein when a parent network type is mapped to a policy contained in one of the policy documents, a child network type of the parent network type inherits the policy.

8. The method according to claim 7, wherein when the child network type is mapped to a policy contained in one of the policy documents that is conflict with the policy inherited from the parent, the policy mapped to the child takes precedence over the policy inherited from the parent.

9. The method according to claim 5, wherein an instance of one of the network types is mapped to one or more physical network segments and wherein the network type includes a set of data fields for defining the physical network segments.

10. The method according to claim 6, wherein one of the network types is an abstract type without an instance mapped to a physical network segment.

11. The method according to claim 5, wherein each network type further comprises a data field for identifying a human administrator.

12. The method according to claim 5, wherein each network type further comprises a data field for providing a human readable description of the network type.

13. The method according to claim 1, wherein the network security policies are representative of restrictions to be placed on one or more of the network roles in the registry data structure.

14. The method according to claim 1, wherein the policy documents are in extensible markup language (XML).

15. The method according to claim 1, wherein the document transformation algorithm is specific to a network entity utilized for implementing one or more of the security policies contained in the policy documents.

16. The method according to claim 15, wherein the document transformation algorithm includes style sheet language for transformation (XSLT) controlled by a script.

17. The method according to claim 16, wherein the script is specific to a network entity.

18. The method according to claim 16, further comprising a step of selecting the script from among a plurality of scripts, each being specific to a different network entity.

19. The method according to claim 16, wherein the device-specific configuration documents are in plain text format.

20. A apparatus for configuring a network security system, comprising:
a. a registry data structure including a plurality of network types, each network type being stored within a document in the registry and including a role definition and a set of fields defining segments of a network;
b. security policy documents mapped to the registry data structure, each security policy document being representative of restrictions to be placed on a network type in the registry data structure; and
c. a document transformation algorithm for transforming the documents in the registry and the policy documents into device-specific configuration documents stored in machine-readable form.
